(19) United States
(12) Patent Application Publication
(10) Pub. No.: US 2014/0180766 A1
(43) Pub. Date: Jun. 26, 2014

(54) SYSTEM AND METHOD FOR GENERATING, TRANSMITTING AND USING CUSTOMIZED SURVEY QUESTIONNAIRES

(71) Applicant: IPerceptions Inc., Montreal (CA)

(72) Inventors: Pierre TETREAULT, Granby (CA); Joshua ZINLER, Montreal (CA); Martin ROY, Drummondville (CA)

(73) Assignee: IPerceptions Inc., Montreal (CA)

(21) Appl. No.: 14/053,724

(22) Filed: Oct. 15, 2013

Related U.S. Application Data
(60) Provisional application No. 61/714,148, filed on Oct. 15, 2012.
(60) Provisional application No. 61/829,458, filed on May 31, 2013.

(51) Int. Cl. G06Q 30/02

(52) U.S. Cl. CPC G06Q 30/0203
USPC 705/7.32

(57) ABSTRACT

The present disclosure provides methods, a web server and a user device for generating, transmitting and using customized survey questionnaires. The methods, web server and user device collect behavioral data of a survey participant through a user device, behavioral data indicative of events occurring during a browsing session with respect to an origin. The method and web server generate a customized survey questionnaire based on the received behavioral data throughout the browsing session with respect to the origin, the customized survey questionnaire comprising one of: a survey question selected among a plurality of survey questions from a survey question database based on the received behavioral data, and a survey question generated based on the received behavioral data.

### FIELD OF THE INVENTION

The present disclosure relates to the field of web surveys; and more particularly to customized questionnaire building in relation with web surveys.

### BACKGROUND

It is very useful for corporations to understand their patrons, and even more to identify the potential intent of their patrons in relation with their brand, services and products, what their patrons like and dislike in the products and services they offer them. Inaccurate identification of the patrons and their opinions may result in important losses, for instance loss of sales, inaccurate responses to the needs of the patrons, loss of fidelity of the patrons to the brand, etc. Accordingly, tools to increase the corporate understanding of patrons, and the validity level associable to this knowledge, has important value for corporations.

Same applies to tools used to interact with these patrons. The more efficient they are, the greater the chances to monetize any interaction therewith. Accordingly, evaluation tools are necessary to establish the efficiently of the tools used to interact with the patrons, including tools used to evaluate websites.

Currently the most commonly used tools to acquire information from website visitors, i.e. understanding the level of success of a website consist in the following: (1) web analytics tools such as Google Analytics™, (2) survey tools, and (3) session recording tools, also known as session replay processes. While the first allows following the actions performed by the visitors of a website (therefore responds to the WHAT question), it fails to provide understanding of the reasons for a visitors to not complete a task (the WHY question) such as not being able to complete a purchase. The second one, while being a good tool to understand the reasons for a visitor for not having completed the task, lacks a capacity to provide only useful questions to the survey respondent, to prevent respondent to provide ill-based responses on not visited webpages for example. The third one remains, as the first tool, based on actions performed by visitors of the website.

Therefore, none of these solutions alone provide a way to improve the questionnaires used in a survey and to increase value of the responses provided by survey respondents.

### SUMMARY

The present relates to customized survey questionnaires.

In an aspect, the present disclosure relates to a method for generating, transmitting and using customized survey questionnaires. The method comprises receiving, at a data collection component, behavioral data from a remote user device, the behavioral data being indicative of events which occurred on a web client hosted by the user device during an ongoing browsing session with respect to an origin. The method further receives, at the data collection component, a survey participation initiation signal from the user device indicative that a survey participation trigger condition is met. The method continues by generating, at a customizing questionnaire engine component, a customized survey questionnaire based on the received behavioral data throughout the browsing session with respect to the origin, the customized survey questionnaire comprising one of: a survey question selected among a plurality of survey questions from a survey question database based on the received behavioral data, and a survey question generated based on the received behavioral data. The method further transmits, by the customizing questionnaire engine component, the customized survey questionnaire to the user device to be responded by a user of the user device. The method also includes receiving, at the data collection component, survey participation data from the user device, and storing the received survey participation data in a survey database, wherein the survey participation data comprises a response to the customized survey questionnaire.

In another aspect, the present relates to a server for generating, transmitting and using customized survey questionnaires. The server comprises a processor, a communication interface for communicating with a user device through a communication network, memory for storing databases, and program code. The program code is responsible, when processed by the processor, for the execution of a behavior tracking component, a survey customizing component, a survey receiving component and a communication component. The behavior tracking component receives, via the communication component, behavioral data from the user device, the behavioral data being indicative of events occurring on a web client hosted by the user device. The behavior tracking component further receives a survey participation initiation signal indicative of survey participation to be conducted on the user device. The survey customizing component generates a customized survey questionnaire based on the behavioral data received during an ongoing browsing session by the behavioral tracking component, the customized survey questionnaire including a survey question selected from a plurality of survey questions based on the received behavioral data. The survey receiving component receives survey participation data from the user device, the survey participation data including a response to the customized survey questionnaire provided by a survey participant via the user device. The communication component exchanges data with the user device, including the behavioral data, the survey participation initiation signal, the customized survey questionnaire and the survey participation data.

In accordance with another aspect, the present relates to a method for generating, receiving and displaying customized survey questionnaires. The method generates and transmits from a user device to a web server a website visit request, to initiate a browsing session with respect to an origin. The method also receives, at the user device, web content comprising a HTML document with embedded instructions in response to the visit request. The method further processes, by the user device, the HTML document including the embedded instructions including instructions for generating and displaying a webpage, instructions for generating a behavioral monitoring component, and instructions for generating a survey conduct component. The method continues by receiving at the user device, an input from a survey participant during the ongoing browsing session with respect to the origin, resulting in the occurrence of an event. The method then detects, the behavioral monitoring component, the event and generating behavioral data indicative of the event and transmitting the behavioral data to the survey server. The method also detects, by the behavioral monitoring component, a survey initiation trigger condition during the ongoing browsing session and transmitting a survey participation initiation signal to the survey server upon the detection thereof. The method also receives, by the survey conduct component, a customized survey questionnaire from the remote survey server including one of the following: a survey question selected among a plurality of survey questions from a survey question database based on the behavioral data, and a survey question generated based on the behavioral data. The method then displays, by the survey conduct component, a survey question according to the received customized survey questionnaire. The method also receives, by the survey conduct component, a response to the survey question from the survey participant and generating survey participation data indicative of the response provided by the survey participant to the survey question. The method then transmits, by the survey conduct component, the survey participation data to the remote server.

In another aspect, the present disclosure relates to a user-device for generating, receiving and customized survey questionnaires. The user-device comprises a processor, a communication interface for communicating with a web server through a communication network, and program code. The program code is responsible, when processed by the processor, for the execution of a behavioral monitoring component and a survey conduct component. The behavioral monitoring component detects occurrence of an event, generates behavioral data indicative of the event, transmits the behavioral data to a survey server, detects a survey initiation trigger condition during the ongoing browsing session, and transmits a survey participation initiation signal to the survey server upon the detection thereof. The survey conduct component receives a customized survey questionnaire from the remote survey server including one of the following: a survey question selected among a plurality of survey questions from a survey question database based on the behavioral data, and a survey question generated based on the behavioral data. The survey conduct component further displays the survey question according to the received customized survey questionnaire, receives a response to the survey question from the survey participant, generates survey participation data indicative of the response provided by the survey participant to the survey question, and transmits the survey participation data to the remote server.

### BRIEF DESCRIPTION OF THE DRAWINGS

In the appended drawings:

FIG. 1 is an exemplary schematic representation of the environment in which the present method is performed;

FIG. 2a is an exemplary schematic representation of the user device illustrated on FIG. 1;

FIG. 2b is an exemplary schematic representation of the runtime environment provided by the web browser component hosted by the user device illustrated on FIG. 1 and FIG. 2a;

FIG. 2c is an exemplary schematic representation of components of the user device of FIG. 1;

FIG. 3 is an exemplary schematic representation of the web server illustrated on FIG. 1;

FIG. 4 is an exemplary schematic representation of the survey server illustrated on FIG. 1;

FIG. 5 is a signal flow exchange between the components illustrated on FIG. 1 according to at least one alternative;

FIG. 6 is a flow chart of the method performed by the user device;

FIG. 7 is flow chart completing the flow chart of the method of FIG. 6, performed by the user device; and

FIG. 8 is a flow chart of the method performed by a survey server.

### DETAILED DESCRIPTION

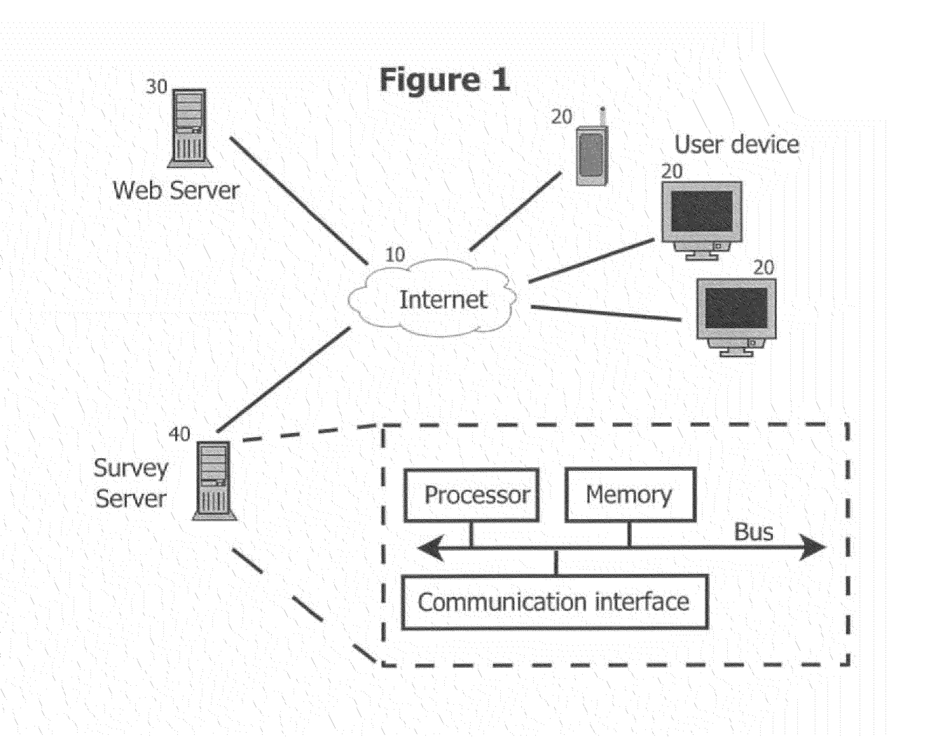

Referring to FIG. 1, there is shown an exemplary schematic network of the environment in which the present methods, server and user device interact. More particularly, the environment includes a network 10, such as the internet, a user device 20 which may be mobile or fixed, a web server 30, and a survey server 40. The user device 20 is adapted for hosting a web client component, which will be describe later. The network 10 may consist of any type of network or plurality of networks, linked or bridged electronically, optically or wirelessly, and permitting communication between the user device 20, the web server 30 and the survey server 40.

For the purpose of the present disclosure, the method, server and user device will be depicted in relation with the above-described environment. However, the reader must understand that this environment is provided only to assist the description of the user device, servers and methods; and it is not intended to limit the user device, servers and methods to the described environment. Furthermore, optional devices (not illustrated) could further be used in the present environment. Examples of optional devices could include a web analytic server and a tag management server.

The user device 20 could consist of any processor-driven device, either mobile or fixed, capable of communicating with a network 10 and allowing a user of the user device to participate in a survey. Examples of user device 20 include desktop computers, laptop computers, tablets such as for example iPad™, smartphones and personal digital assistants (PDAs) which all share the characteristics of being able to host a web client, such as a web browser, and to communicate with remote devices over the network. Other user devices which share similar characteristics to those previously mentioned, regardless of their technical purpose (purpose-specific such as smart televisions and appliances for instance), could also be used as user device in the context of the present disclosure. Throughout the present disclosure, the expressions “processor-based devices” and “user devices” are used as equivalents.

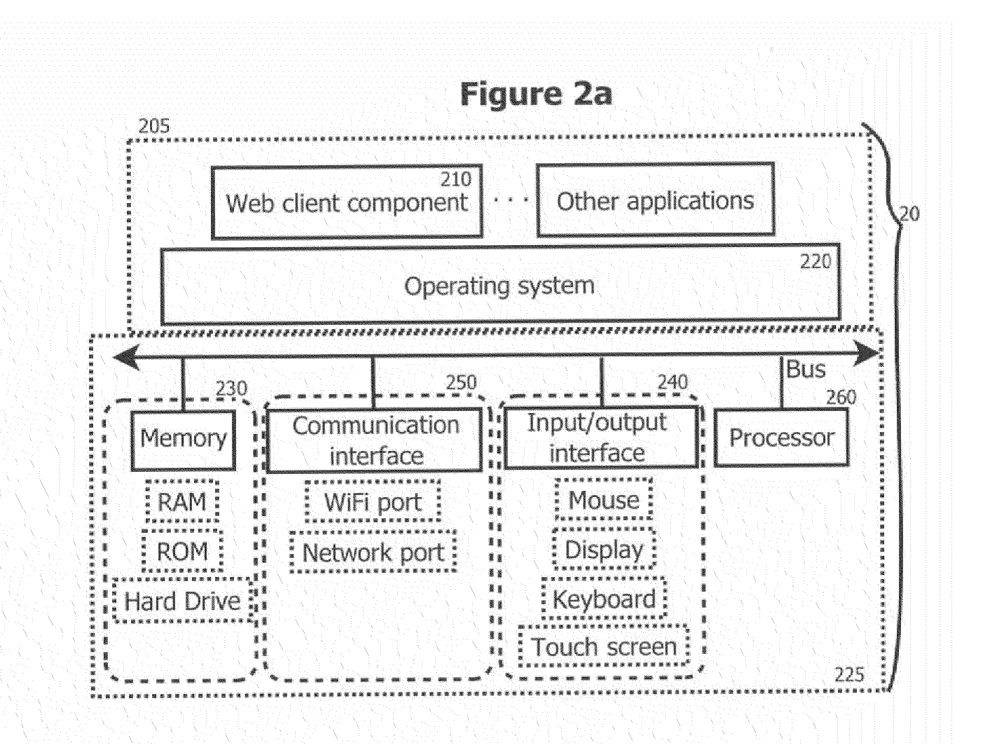

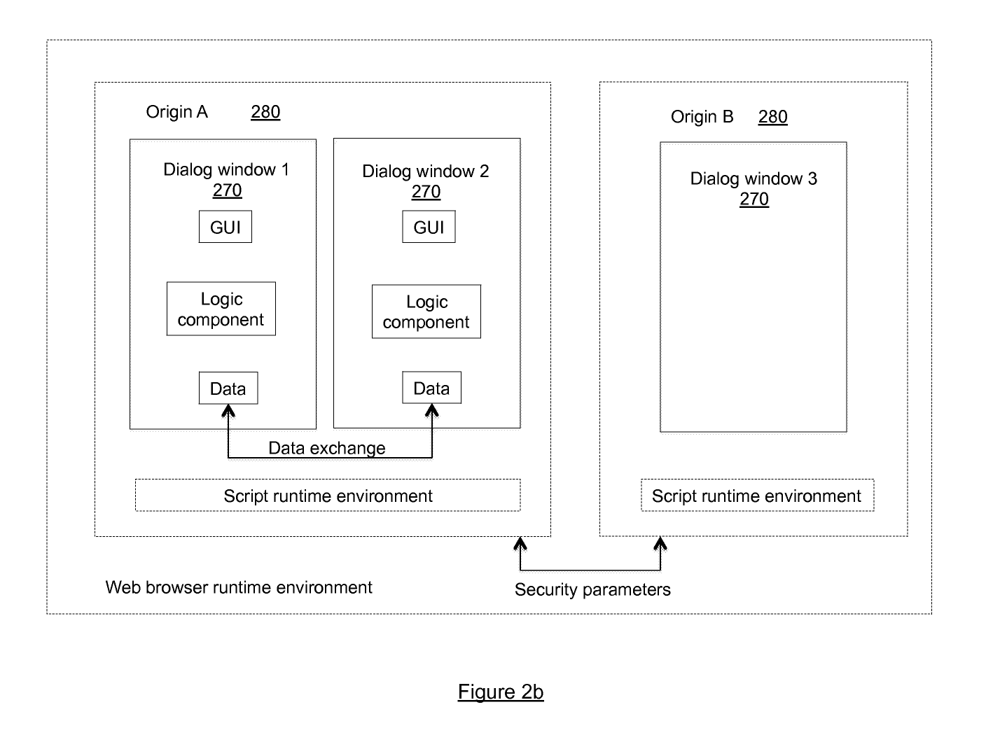

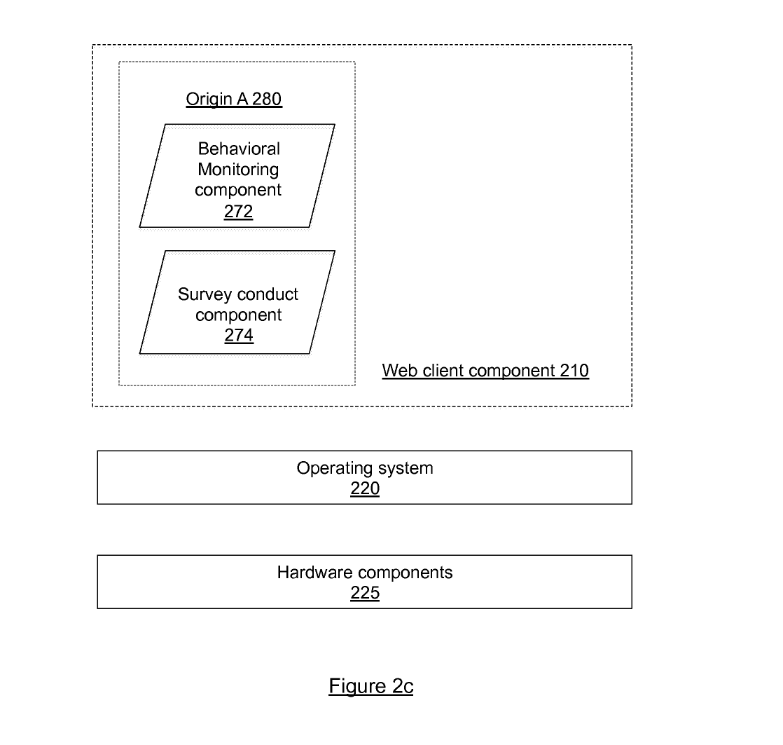

Reference is now made to FIG. 2a, which schematically illustrates exemplary hardware and software components of the user device 20. The user device 20 comprises hardware components 225 and software components 205 resulting from codes stored on memory 230, which when processed generate software components 205. A web client component 210 is hosted by the user device 20. The web client component 210 may either be manufactured with the user device 20, or the web client component 210 may be installed later. The illustrated web client 210 may consist in a web browser such as Microsoft Internet Explorer™, Google Chrome™, Apple Safari™ or Mozilla Firefox™ to list a few. Other web client components 210, usually web client components 210 customized for specific tasks and/or processes and designed to communicate with specific servers, may be available such as those developed under the Adobe Integrated Runtime (AIR) or Windows Runtime (WinRT) environment. The hardware components 225 comprise a processor 260, memory 230, input/output interface 240 and a communication interface 250 to communicate over the network. The web client component 210 interacts with the hardware components 225 through the processor 260, to access memory 230 for reading and writing data stored therein, to communicate with servers, to display web pages and survey questionnaire, to receive input from a user of the user device for instance trough keyboard and mouse controls, etc.

Reference is now concurrently made to FIGS. 2a and 2b. Specifically on FIG. 2b, the web client component 210 is a web browser adapted to access websites, by exchanging data packets with web servers, and downloading and processing web content, such as HTML documents, provided by the visited web servers. The web browser provides the user of the user device 20 access to webpages. The web browser is further adapted to provide the necessary runtime environment for processes to be performed when HTML documents feature embedded instructions (also called scripts). The web browser is also adapted to apply security policies restrictions to apply in relation with the provided runtime environment. The security policies for instance limit accessibility of information and processes according to origin identification, therefore isolating data relative to a dialog window with respect to one origin from another dialog window (and associated processes) with respect to another origin. The web browser can also store in the memory 230, codes to be executed according to runtime environment policies, such as scripts and cookies. The web browser further provides, one or more dialog windows 270 according to processes performed in relation with a web browsing session and/or origin identification 280. The dialog windows 270 may be part of the same browsing session, and/or based on a domain visited during the browsing session. The origin identification 280 establishes a security parameter, isolating information, logical components and resulting processes according to one browsing session with respect from another browsing session based on the origin identification rather than graphical presentation in the web browser interface.

Web browsers are instructions executed by the processor 260. During the execution of the instructions, the processor 260 may: access the memory 230, use the communication interface 250 to send and receive data packets, and rely on the input/output interface 240 to obtain inputs from the user, display web pages on the display, etc. Upon visit of a website, data packets received from the corresponding web server to generate and display the webpages, may include: HTML documents, Content Style Sheets capable of providing display layouts and rules used to determine the layout for generating the webpage to be displayed, and discrete web content to be integrated in the displayed webpage independently from the webpage structure provided by the HTML document and the Content Style Sheet. Examples of discrete web contents include text elements, images, sounds, videos and animations to list a few. According to this definition, website visit content must include at least one HTML document, and may include a Content Style Sheet and zero to multiple discrete web contents to be integrated in the webpage(s) to be displayed.

Reference is now concurrently made to FIGS. 2a, 2b and 2c. More particularly, FIG. 2c depicts a schematic of the user device 20 functional structures specifically in relation with the web client 210. The functional structure comprises a plurality of logical components (a behavioral monitoring component 272 and a survey conduct component 274) that are generated, on processing of instructions according to the web client runtime environment. These logical components 272 and 274 will be described herein below. The logical components 272 and 274 operate within the security parameters set based on an origin to which they are associated.

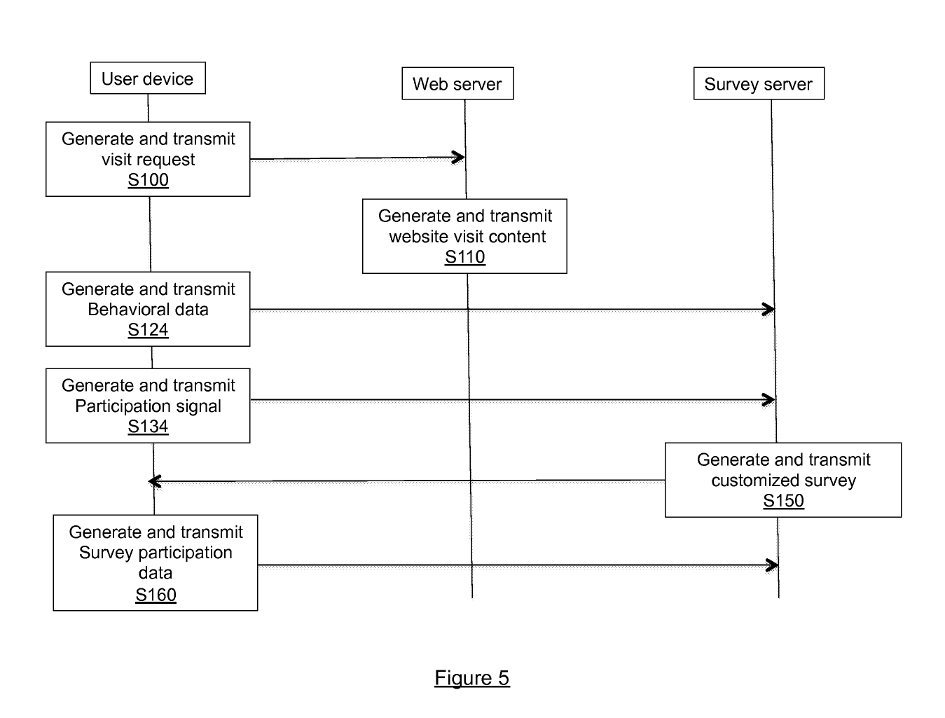

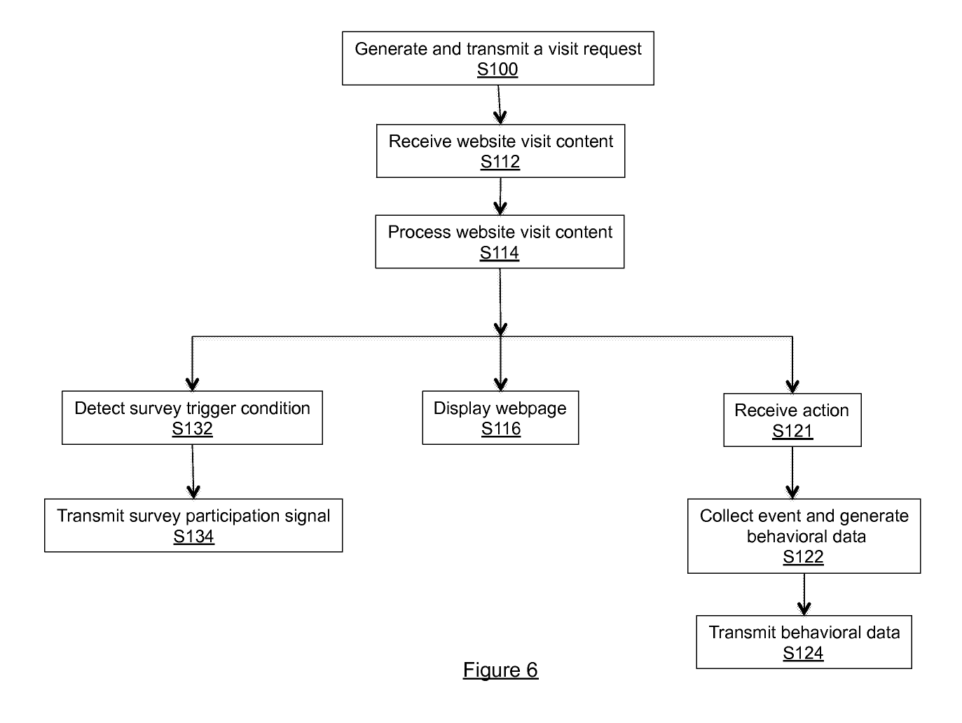

Reference is now concurrently made to FIGS. 5 and 6, which respectively depict a signal flow and method performed by the user device 20. The method performed by the user device 20 comprises the following steps. At step S100, the web client component 210 generates and transmits a website visit request, through the communication interface 250, to the web server 30. The visit request is normally characterized in the URL requested to the web server 30 (or a series of servers) responsible to respond to visit requests relative to the website. At step S112, the web client component 210 receives from the web server 30 web content, in response from the visit request. As stated above, the web content transmitted by the web server 30 may contain content style sheet (CSS) and discrete web content, and must include a HTML document. At step S114, the user device 20, according to the runtime environment provided by the web client component 210, processes the HTML document and the optional additional data transmitted by the web server 30. Processing the web content includes generating the webpage to be displayed on the user device, and processing of the instructions (e.g. scripts in a high-level language such as Java Scripts) embedded in the HTML document or other web content.

The instructions embedded in the HTML document may relate to services provided by a tag manager server (not illustrated). In this case, processing of the embedded instructions triggers communication with the tag manager server, which sends additional instructions to the user device 20. The transmitted instructions are afterwards processed by the user device 20 as if they were embedded in the web content transmitted by the web server 30. Accordingly, instead of integrating a plurality of scripts in their web content, a website owner may use tag(s) to communicate all of them using a single web content embedded script.

At step S116, the user device 20 displays, for instance on a screen, the webpage resulting from the processing of the web content. At step S121, the user device 20 receives an action from the user, that action resulting in an event according to the ongoing browsing session with respect to the origin. Examples of events are numerous, from a click on a hyperlink, filling a form, starting a complex process such as a wizard, starting the play of music or a video, scrolling down of a displayed webpage to render a portion of the webpage visible, etc. At step S122, the behavioral monitoring component 272 on the user device 20, generated according to the processing of instructions embedded in the received HTML document and processed according to the web client runtime environment, initiates a behavioral monitoring and transmission process. The behavioral monitoring and transmission process performed by the behavioral monitoring component 272 collects behavioral data indicative of events occurring on the user device 20 with respect to the ongoing browsing session.

At step S124, the behavioral monitoring component 272 further transmits the collected behavioral data to the survey server 40. The behavioral monitoring component 272 also detects when a survey participation trigger condition occurs or is met on the user device 20, and transmits a signal to the survey server 40 whenever the trigger condition occurs. Depending on the event and circumstances around the event, the transmitted behavioral data may be a clear indication of the event itself (e.g. click of hyperlink www.website.com/newpaqe.html) or less specific indication such as one particular process, a series of events, or any other behavioral data of the user in the course of the browsing session (e.g. filing of form Form_Name). The behavioral data may be transmitted following the monitoring of an event, therefore transmitting event by event during the browsing session. The behavioral data may be transmitted for a series of events. The transmission process may be triggered when the number of events reaches a particular level. The transmission process may alternatively be triggered when a particular condition arises such as a change of webpage, a predetermined time period being reached since the last transmission, occurrence of a particular event, etc. Determining when to transmit the behavioral data, based on one or more of the above alternative and one or more of the above conditions, may be provided in the script received in the webpage, determined solely by the user device, or as a combination of both. Transmission of the behavioral data may also be based on performance criteria, such as for instance, performance on the user device, performance on the receiving server, performance versus the communication network, and/or scalability.

Even if the steps S122 and S124 have herein been described in sequence, one must understand that a number of webpage requests may take place during the visit of the website. Accordingly, numerous events will take place and will be monitored along with the website visit.

According to an optional alternative, the processing of the embedded instructions related to the conduct of a survey generates a survey conduct component 274 generating and displaying on the user device 20 an invitation to participate in a survey. That participation may take the form of an additional window in which the survey invitation is displayed, or may take the form of an overlay window displayed over the webpage. Once the user provides a response to the invitation (among them accepting the invitation, or refusing the invitation through the appropriate selection or simply closing the window) using any appropriate input component 240 of the user device 20, the invitation window is closed and the user may resume the browsing session.

Generation of the behavioral monitoring component 272 is conditional to the user accepting to participate in the survey. If the user refuses the invitation, no monitoring and transmission process takes place.

Acceptation of the invitation by the user triggers the generation of the behavioral monitoring component 272, which takes the visual form of a new window being opened with a URL parameter set for example to about:blank; that new window being processed in the web-client runtime environment according to the webpage origin, or in other words the webpage according to which the new window opening process has been initiated. Therefore, a series of windows are opening while remaining within the origin security restrictions. Furthermore, since the instructions responsible for the opening of the last window result on instructions coded according and pointing to the survey server 30, the survey server 30 receives from the user device 20 at the opening of the window the communication parameters to inject new instructions to be processed with respect to that new window, and therefore the same origin. Accordingly, the behavioral monitoring component 272 performs the monitoring and transmission process in association with the window generated according to the about:blank parameter. The behavioral monitoring component 272 is able, according to injected instructions, to monitor the events occurring in the main window, or in other words the first window according to which the website visit has been initiated.

In the context of the present disclosure, the term ‘monitoring’ should be understood in a broad manner. Monitoring may include tapping the communication between the user device and the web server with respect to the window used to visit the website using instructions. Monitoring may include forcing storing of event information in a cookie, and/or reading of the stored cookie information for transmission, monitoring of predetermined events, etc. Accordingly, a variety of events or data may be collected in relation with the monitoring.

At step S132, the behavioral monitoring component 272 of the user device 20 detects that a survey participation trigger condition has been fulfilled and or met. In one alternative, the trigger condition consists in the user closing the window used to visit the website. In another alternative, the trigger condition consists in the monitoring of a particular event, such as a purchase process being completed using the website. The nature of the trigger condition may even be website visit duration. Combination of conditions, or first to occur condition among a list of trigger conditions may also be used. Accordingly, the nature of the trigger condition is a question of objective, and requires only one or several parameters that can be verified by the processor.

The monitoring of the survey participation trigger condition performed by the behavioral monitoring component 272 may either or not require an active process. If a local event is selected as trigger condition, for instance closing of a window, an active process is necessary. However, if the trigger condition results by itself in data exchange, for instance with the survey server (ex. clicking on an icon with an associated hyperlink point to the survey server), no particular monitoring may be required.

At step S134, the behavioral monitoring component 272 of the user device transmits to a survey server 40 a survey participation initiation signal generated based on the survey participation trigger condition being satisfied.

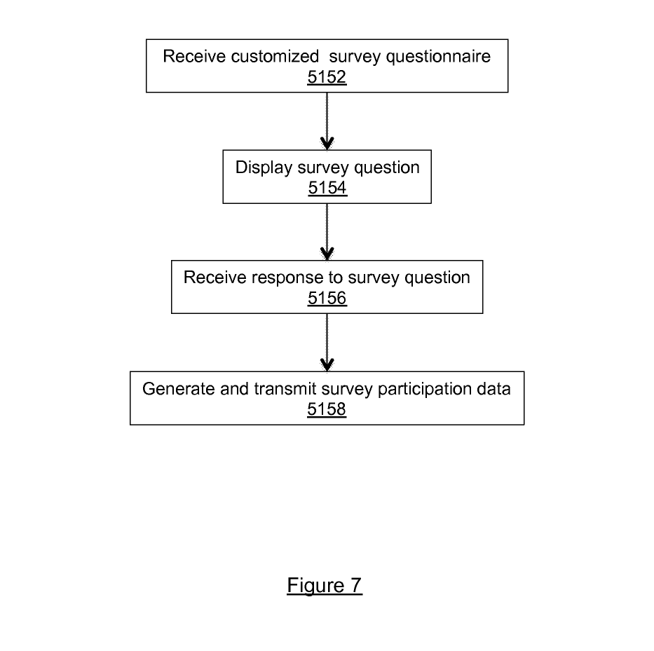

Reference is now concurrently made to FIGS. 5 and 7. At step S152, the survey conducting component 274 of the user device 20, via the communication interface 250, receives a customized survey questionnaire to display to the user of the user device 20 allowing participation in a survey. The customized survey questionnaire comprises one or more questions selected based on the events monitored by the behavioral monitoring component 272 and transmitted to the survey server 40. For instance, the customized survey questionnaire may include a question on the purchase process and associated webpages only if the user has performed a purchase during their website visit. Another example may be to include in the customized survey questionnaire a question on a previous visit if the user has used the login process on the web site. These are only examples of possible customization; the breath of the customization is only limited by the events that can be monitored and the survey objectives.

Format of the customized survey questionnaire is as broad as with any other web survey. Survey questions in one alternative may be provided in a series of windows wherein only one or two questions are provided at a time, while in another alternative the questions are assembled in a single user interface and provided together. The nature of the responses, namely ratings, ordering of elements, selection of an element among a series of available elements, graphic controls to provide responses such as sliding control on a graduate ruler, and open-ended questions wherein the survey participant provides a response in their own words in a free-text format are all available solutions. A mix of these solutions may also be used to receive responses from a survey participant. The selection of the form is only a question of context, as all of these solutions are already known and part of the state or the art.

At step S154, the survey conducting component 274 of the user device 20 displays, via an output interface 240, the customized survey questionnaire. At step S156, the survey conducting component 274 of the user device 20 receives responses to the survey question(s) from the survey participant. The number of questions may be limited to one, or may include responses to a series of questions provided according to one or more of the above-discussed forms. At step S158, the survey conducting component 274 of the user device 20 communicates data indicative of the responses receives in relation with of the survey questionnaire, namely survey participation data, to the survey server 40.

According to an alternative wherein the survey participation trigger condition is fulfilled when the website visit window is closed, the survey conduct component 274 forces the window used by the behavioral monitoring component 272 to get in front of any other window. Upon reception of the survey responses from the survey participant, survey participation data is transmitted to the survey server 40 followed with window being closed, therefore ending the browsing session.

Throughout the present disclosure, the expression “customized survey questionnaire” refers to a questionnaire built based on events monitored before the beginning of the conduct of the survey participation on the user device, and excludes events monitored during the conduct of a survey participation, also known as skip-logic. It is known in the art to customize a survey questionnaire based on responses provided by a survey participant in one or more questions to the same survey questionnaire. These concepts and processes are different and should not been confused, although it would be possible to combine to the present ‘customized survey questionnaire’.

Although the present processes have been described as resulting from execution of web-content embedded instructions, the web-content embedded instructions could alternatively and/or concurrently initiate a process of setting a communication between the user device 20 and the survey server 40. Hence, once instructions provided by a first script are processed according to the web client runtime environment, communication exchanges may occur between the survey server 40 and the user device 20 (under control of the process) wherein parameters, data, signals, and scripts (including additional instructions) may be communicated to the user device 20. Accordingly, already running processes and running components may take into account the newly communicated data (ex. a customized survey questionnaire) and new logical components may be generated when these additional instructions are processed according to the web client runtime environment. These exchanges and these initiations of new components and processes are typically invisible to the user of the user device 20; everything being performed without intervention and/or knowledge of the user of the user device 20.

The script to allow interaction between the user device 20 and the survey server 40 may be embedded in the web content to be provided by the web server. Once processed by the processor of the user device, the running process exchange data with the web server 30: a) to determine if the user device 20 should participate in a survey, b) to initiate a survey invitation process, c) to initiate an event monitoring process, d) to initiate and control a behavior data transmission process, e) to initiate a survey participation trigger condition monitoring process, f) to initiate and control a survey participation initiation signal, g) to generate one or more survey questionnaire windows, h) to initiate a survey response collection process, and i) to initiate and control a survey participation data transmission process. To perform all these processes, the data exchange between the user device 20, which runs the pertinent components for these processes, and the survey server 30 takes place at different times throughout and concurrently with the browsing session.

The above steps have been provided as distinct steps in a non-limiting order. Some steps, even though expressed as distinct processes, may take place simultaneously, or may participate in the same signal transmission for instance. Hence, the expression ‘step’ are to be construed more largely so as to encompass related process definitions, regardless if discrete processes are performed at the same time, together or through the same component for instance.

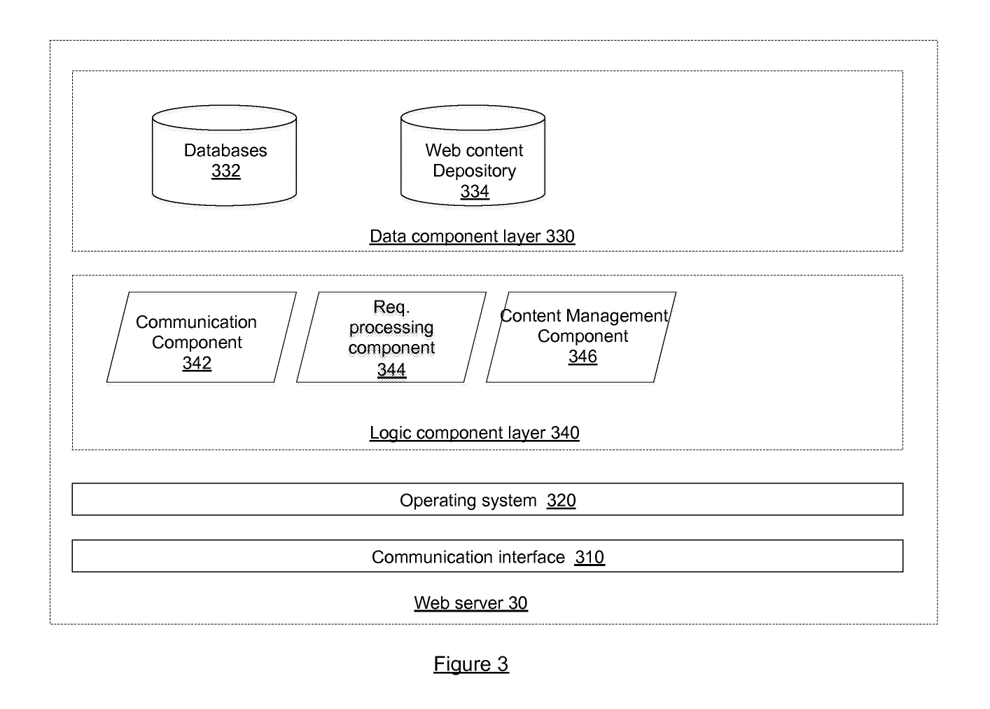

Reference is now made to FIG. 3, which is a schematic overview of the functional components of the web server 30. The web server 30 includes a communication interface 310, an operating system 320, memory storing code which when executed embody as a data component layer 330 (dedicated to data storage) and a logic component layer 340 (dedicated to processes). The logic component layer 340 can be functionally divided into three components: a communication component 342 for controlling the communications with the user devices and survey server, a request processing component 344 for handling website visits and other communications with user devices and the survey server, and a content management component 346 (also called Web Content Manager—WCM) adapted to generate website visit content. The data component layer 330 may be functionally divided as follows: databases 332 for storing data and parameters, and a web content depository 334 for storing web content.

The term “web server” in the present disclosure should be interpreted to encompass a broad definition, namely a processor-based device performing several functions such as responding to website visit requests, and providing HTML documents and other web content to user devices over a network such as the Internet. These functions may be executed by a plurality of slave servers completing altogether the functions of the described web server, or may involve additional functions while remaining within this broad definition. Communication with the web server is typically performed according to a TCP/IP protocol, but is not limited to that protocol.

Similarly, the term “server” must be construed as a processor-based device in communication with other devices over the Internet or an intranet and able to perform specialized tasks based on exchange of communication with user devices and survey server over a network such as the Internet.

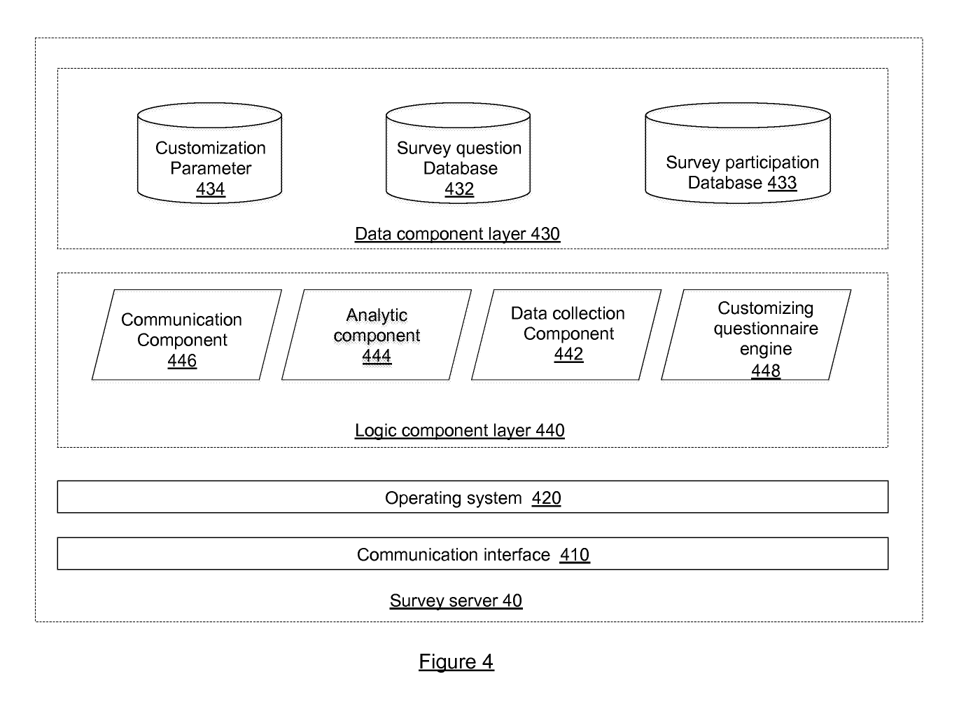

Reference is now made to FIG. 4 which schematically depicts the functions of the survey server. The survey server 40 comprises a communication interface 410, an operating system 420, and memory storing code corresponding to a data component layer 430 (dedicated to data storage) and a logic component layer 440 (dedicated to processes). The data component layer 430 is used to store the survey participation data (in a survey participation database 433), survey questions and survey question building data, for instance sentence models (in a survey question database 432) and, customization parameters used to generate customized survey questionnaires (in a customization parameter database 434). The logic component layer 440 comprises, once the instructions present in the code are processed, the following components: a data collecting component 442 (survey collecting component) used to collect the survey participation data from web browsers and to store the survey data in the survey database 432, an analytic component 444 for analysing the collected survey data to generate survey participation data and generate reports, a communication component 446 for handling communications, including exchange with web browsers and the transmission of the outcome generated by the analytic component to the web server, and a customizing questionnaire engine component 448 used to generate customized survey questionnaires.

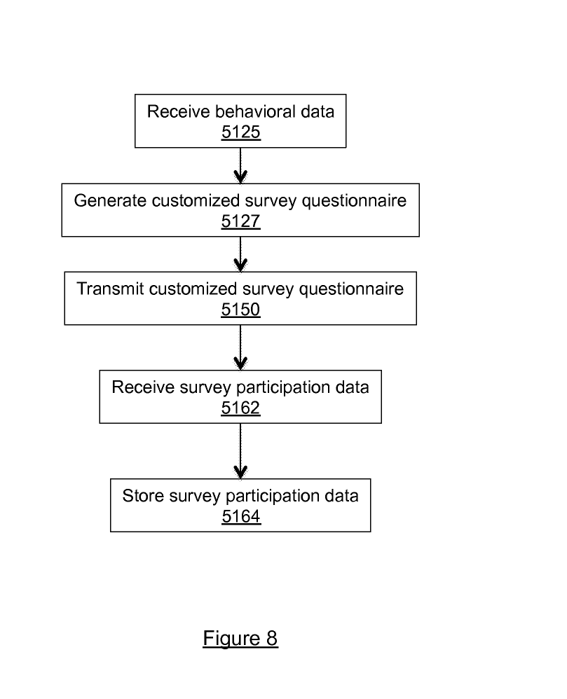

Reference is now made concurrently to FIGS. 5 and 8, which depict the method performed by the survey server 40. At step S125, the data collection component 442 of the survey server 40 receives behavioral data from the user device 20. The behavioral data are indicative of events that occurred on the user device in respect with a visit of a website. At step S127, the customizing questionnaire engine component 446 of the survey server 40 processes the received behavioral data to determine the useful information on events that occurred on the user device 20. The customizing questionnaire engine 446 of the survey server 40 passes through an algorithm the collected behavioral data, uses survey questions stored in the survey database 432 in view of customization parameters collected from the customization parameter database 434 to generate a customized survey questionnaire.

According to an alternative, the customized survey questionnaire includes a survey question selected among a plurality of survey questions selected from the survey database 432 based on the received behavioral data. The outcome is one or more questions referring only (according to customization parameters) to events that occurred on the user device 20 during the browsing session. Alternatively, the customized survey questionnaire includes a survey question generated based on the received behavioral data. Accordingly, the customization question engine component 446 generates at least one questions related to events that occurred on the user device during the browsing session. For instance, a question may be generated using information provided in a form such as the login form of the website.

Furthermore, generating a customized survey questionnaire may include selecting a generic question and compiling a new question using data indicative of one or more events encountered during the browsing session. For instance, the generic question may ask the survey participant their level of satisfaction before performing a “log out” action at time “T” when the received the behavioral indicates that a log out action has been performed at the time “T”. Another example may be to ask the survey participant to provide level of satisfaction in relation with a list of actions, wherein each listed action is validated from the received behavioral data. Accordingly, based on the one or more questions selected and/or generated based on the received behavioral data, a customized survey questionnaire may be generated.

At step S150, the communication component 446 of the survey server 40 transmits the customized survey questionnaire to the user device 20. The customized survey questionnaire may take many forms, including a XML document including the survey questionnaire, a XML document including only parameters necessary to generate the questions part of the customized survey questionnaire on the user device 20. Another alternative consists in a list of questions transmitted in a XML document indicative of questions to be part and questions to be avoided in the conduct of a survey participation on the user device 20 according to the survey questionnaire. The present list is not exhaustive, and is not limited in format (XML document, text document, encrypted data packets, etc.) and content (questions, list of question identifiers, parameters, etc.).

At step S162, the communication component 446 of the survey server 40 receives survey participation data from the user device 20. The survey participation data includes at least the responses to the customized survey questionnaire provided by the user of the user device. The survey participation data may take many forms, including a XML document wherein both survey questionnaire and survey responses are included. Another alternative, for illustrative purpose, consists in a data packet comprising only the answers to the customized survey questionnaire, and browser session identifier. At step S164, the data collection component 442 stores the survey participation data in the survey participation database 433 for future analysis by the analytic component 444.

### Customized Survey Questionnaire and Survey Participation Data Format

The customized survey questionnaire or the survey participation data may take various forms, as already known in the art. For example, a question database comprising a table composed of a question in a first field, and a set of associated events in a second field could be used. When generating the customized survey questionnaire, a virtual table would be generated with a third flag field appended to the other two fields. For each question, when an event in listed in the processed behavioral data, the flag field would be turn to positive. Once all questions are processed, all rows with no positive flag are erased from the virtual table. Therefore, only questions pertaining to the events occurring during the browsing session would remains based on the transmitted behavioral data. Thereafter, a process could be performed according to a survey algorithm to determine which, if not all, of the remaining questions of the virtual table should be included in the customized survey questionnaire. Finally, a questionnaire file would be generated in a XML format to be transmitted to the user device.

When receiving the survey participation data, the data could also be transmitted in a XML format, with both the questions and the provided answers included in the file. When the survey participant skipped questions, the XML file could include an indication to that effect, namely a “skipped” indication. Once received, the survey participation data could be processed so that the survey database include for each survey participation the list of all possible questions, a flag field associated with each question establishing if the question has been included or not in the customized survey questionnaire, and the associated response from the survey respondent for included questions, and an empty field for the others.

Alternatively or concurrently, a list of events considered to generate the customized survey questions could be integrated in a field for each survey participation. Additionally, the survey server could collect and store additional data in the survey database such as a session identifier, a browser type, screen definition information, a set of visited webpages, time of visit information, flag information for highly pertinent information on the survey respondent such as recurring flag for recurring survey respondent, purchase flag for survey respondent who performed a purchase during the browsing session in which the survey participation data has be provided, etc.

The behavioral collecting component of the user device may further remain active during the participation to the customized survey, and may further collect information on events occurring on the user device when the survey responses are provided, such as times of response of the different questions, scrolling data informing if the display window has modified or not in order for the question to become visible to the survey participant, etc. Use of such information may, for instance, be used to evaluate automated responses.

Survey communication language such as Triple-S XML may be used to transmit the customized survey questionnaire to the user device, and to transmit the survey participation data to the survey server. This communication language allows simple transfer to a survey analytic server. Other alternatives, like Quantum or Snap languages could for example be used to code the survey data.

Although the present methods, web server, survey server and user device have been described in the foregoing description by way of the provided illustrative embodiments, these embodiments are not intended to limit the scope of protection sought. Other embodiments could have been provided that would also have been within the limitations of the present disclosure as within the scope defined by the appended claims.

1. A method for generating, transmitting and using customized survey questionnaires, the method comprising:
receiving, at a data collection component, behavioral data from a remote user device, the behavioral data being indicative of events which occurred on a web client hosted by the user device during an ongoing browsing session with respect to an origin;
receiving, at the data collection component, a survey participation initiation signal from the user device indicative that a survey participation trigger condition is met;
generating, at a customizing questionnaire engine component, a customized survey questionnaire based on the received behavioral data throughout the browsing session with respect to the origin, the customized survey questionnaire comprising one of: a survey question selected among a plurality of survey questions from a survey question database based on the received behavioral data, and a survey question generated based on the received behavioral data;
transmitting, by the customizing questionnaire engine component, the customized survey questionnaire to the user device to be responded by a user of the user device;
receiving, at the data collection component, survey participation data from the user device; and storing the received survey participation data in a survey database,
wherein the survey participation data comprises a response to the customized survey questionnaire.

2. A computer program for generating, transmitting and using customized survey questionnaires in accordance with claim 1.

3. A server comprising a computer readable memory storing computer executable instructions thereon that when executed by a computer processor performs the method of claim 1.

4. A server for generating, transmitting and using customized survey questionnaires, the server comprising:
a processor;
a communication interface for communicating with a user device through a communication network; and
memory for storing databases; and
program code responsible, when processed by the processor, for the execution of the following:
a behavior tracking component for receiving, via the communication component, behavioral data from a the user device, the behavioral data being indicative of events occurring on a web client hosted by the user device, and for receiving a survey participation initiation signal indicative of a survey participation to be conducted on the user device;
a survey customizing component for generating a customized survey questionnaire based on the behavioral data received during an ongoing browsing session by the behavioral tracking component, the customized survey questionnaire including a survey question selected from a plurality of survey questions based on the received behavioral data;
a survey receiving component for receiving survey participation data from the user device, the survey participation data including a response to the customized survey questionnaire provided by a survey participant via the user device; and
a communication component exchanging data with the user device, including the behavioral data, the survey participation initiation signal, the customized survey questionnaire and the survey participation data.

5. The server of claim 4, wherein the databases comprise:
a behavior database for storing the received behavioral data;
a survey question database for storing a plurality of questions; and
a survey participation database for storing the received survey participation data.

6. A method for generating, receiving and displaying customized survey questionnaires, the method comprising:
generating and transmitting from a user device to a web server a website visit request, to initiate a browsing session with respect to an origin;
receiving, at the user device, web content comprising a HTML document with embedded instructions in response to the visit request;
processing, by the user device, the HTML document including the embedded instructions including instructions for generating and displaying a webpage, instructions for generating a behavioral monitoring component, and instructions for generating a survey conduct component;
receiving at the user device, an input from a survey participant during the ongoing browsing session with respect to the origin, resulting in the occurrence of an event;
detecting, the behavioral monitoring component, the event and generating behavioral data indicative of the event and transmitting the behavioral data to the survey server;
detecting, by the behavioral monitoring component, a survey initiation trigger condition during the ongoing browsing session and transmitting a survey participation initiation signal to the survey server upon the detection thereof;
receiving, by the survey conduct component, a customized survey questionnaire from the remote survey server including one of the following: a survey question selected among a plurality of survey questions from a survey question database based on the behavioral data, and a survey question generated based on the behavioral data;
displaying, by the survey conduct component, a survey question according to the received customized survey questionnaire;
receiving, by the survey conduct component, a response to the survey question from the survey participant and generating survey participation data indicative of the response provided by the survey participant to the survey question; and
transmitting, by the survey conduct component, the survey participation data to the remote server.

7. A computer program for generating, receiving and displaying customized survey questionnaires in accordance with claim 6.

8. A user device comprising a computer readable memory storing computer executable instructions thereon that when executed by a computer processor performs the method of claim 6.

9. A user-device for generating, receiving and customized survey questionnaires, the user-device comprising:
a processor;
a communication interface for communicating with a web server through a communication network; and
program code responsible, when processed by the processor, for the execution of the following components:
a behavioral monitoring component for:
detecting occurrence of an event;
generating behavioral data indicative of the event;
transmitting the behavioral data to a survey server;
detecting a survey initiation trigger condition during the ongoing browsing session; and
transmitting a survey participation initiation signal to the survey server upon the detection thereof;
a survey conduct component for:
receiving a customized survey questionnaire from the remote survey server including one of the following: a survey question selected among a plurality of survey questions from a survey question database based on the behavioral data, and a survey question generated based on the behavioral data;
displaying, the survey question according to the received customized survey questionnaire;
receiving a response to the survey question from the survey participant;
generating survey participation data indicative of the response provided by the survey participant to the survey question; and
transmitting the survey participation data to the remote server.
